(19) United States
(12) Patent Application Publication
(10) Pub. No.: US 2026/0105587 A1
(43) Pub. Date: Apr. 16, 2026

(54) SYSTEM FOR MEASURING ASSEMBLING LENGTH OF CLAMPING ARM OF HAND TOOL AND METHOD THEREOF

(71) Applicant: INDUSTRIAL TECHNOLOGY RESEARCH INSTITUTE, Hsinchu (TW)

(72) Inventors: Ko-Shyang WANG, Tainan City (TW); Guan-Lin LI, Tainan City (TW); Kai-Shiang GAN, Tainan City (TW); Chung-Li TAI, Tainan City (TW)

(73) Assignee: INDUSTRIAL TECHNOLOGY RESEARCH INSTITUTE, Hsinchu (TW)

(21) Appl. No.: 19/062,501

(22) Filed: Feb. 25, 2025

(30) Foreign Application Priority Data
Oct. 16, 2024 (TW) 113139386

(51) Int. Cl. G06T 7/00; G06T 1/00; G06T 5/70; G06T 5/73; G06T 7/12; G06T 7/60; G06T 7/73

(52) U.S. Cl. CPC G06T 7/0006; G06T 1/0014; G06T 5/70; G06T 5/73; G06T 7/12; G06T 7/60; G06T 7/74; G06T 2207/10028; G06T 2207/20081; G06T 2207/20192; G06T 2207/30164

(57) ABSTRACT

A system and method for measuring assembling length of clamping arm of hand tool are provided by the disclosure. The method includes: obtaining a tip region and a base region for respectively obtaining a tip edge 3D feature, a pivot body 3D feature and a pivot edge 3D feature respectively corresponding to a tip portion and a pivot portion of the hand tool, according to a 3D point cloud and a 2D image; calculating a length measuring vector according to the 3D point cloud, the 2D image, the pivot body 3D feature and the pivot edge 3D feature; obtaining a tip tangent plane corresponding to the tip edge 3D feature, and a pivot tangent plane corresponding to the pivot edge 3D feature; and calculating the distance between the tip tangent plane and the pivot tangent plane, to obtain the assembling length of the clamping arm.

This application claims the benefit of Taiwan application Serial No. 113139386, filed Oct. 16, 2024, the disclosure of which is incorporated by reference herein in its entirety.

### TECHNICAL FIELD

The disclosure relates to a system for measuring assembling length of clamping arm of hand tool, and to a method for measuring assembling length of clamping arm of hand tool.

### BACKGROUND

The high-end hand tools have strict tolerance requirements for each clamping arm, and the matching of each clamping arm can be only relied on manual measurement. Due to the loss of the mold during the production process, the sizes of each clamping arm (the size or length for assembling) can be different, and, after assembly, each clamping arm of the product may be interfered by each other while operating due to size differences of each clamping arm, which affects accuracy specifications of the blade tip or the pliers tip opening. Meanwhile, due to the lack of effective matching methods before clamping arms not yet being assembled (semi-finished product), specification inspections can only be performed after the hand tool (finished product) being assembled. Thus, if the finished product fails, it must be disassembled and returned to the manufacturing site for reworking, which results heavy reworking loads. Therefore, the techniques for classifying the assembling length according to the measured dimensions from automatically measuring which before assembling the hand tool in advance.

### SUMMARY

The disclosure is directed to techniques of method and system for measuring assembling lengths of clamping arms of the hand tool, which, by using 3D vision camera, obtains the 3D point cloud and the 2D image of each clamping arm of the hand tool, to measure the size of the assembling length according to edge 3D features and the tangent plane sets, and to classify the assembling length, which facilitates assembling corresponding clamping arms with same assembling length classification to increase the assembly accuracy of the hand tool.

According to one embodiment, a method for measuring assembling length of clamping arm of hand tool is provided. The method includes obtaining, by using a 3D vision camera scanning the clamping arm, a 3D point cloud and a 2D image of the clamping arm. The method also includes obtaining, by a computing device, a tip edge 3D feature corresponding to a tip portion of the clamping arm, according to the 3D point cloud and the 2D image. The method also includes obtaining, by the computing device, a pivot body 3D feature and a pivot edge 3D feature corresponding to a pivot portion of the clamping arm, according to the 3D point cloud and the 2D image. The method also includes calculating, by the computing device, a length measuring vector, according to the 3D point cloud, the 2D image, the pivot body 3D feature and the pivot edge 3D feature. The method also includes obtaining, by the computing device, a tip tangent plane corresponding to the tip edge 3D feature, and a pivot tangent plane corresponding to the pivot edge 3D feature, according to the length measuring vector. The method also includes calculating, by the computing device, the distance between the tip tangent plane and the pivot tangent plane, to obtain the assembling length of the clamping arm. The length measuring vector is a plane normal vector of the tip tangent plane and the pivot tangent plane.

According to another embodiment, a system for measuring assembling length of clamping arm of hand tool is provided. The system includes a jig tray configured for holding the clamping arm. The system also includes a 3D vision camera configured to scan the clamping arm in the jig tray, to obtain a 3D point cloud and a 2D image of the clamping arm. The system also includes a computing device, coupled to the 3D vision camera and comprising a processor. The processor is configured to perform following operations: obtaining a tip edge 3D feature corresponding to a tip portion of the clamping arm, according to the 3D point cloud and the 2D image; obtaining, by determining a pivot portion of the clamping arm, a pivot body 3D feature and a pivot edge 3D feature in the pivot portion, according to the 3D point cloud and the 2D image; calculating a length measuring vector, according to the 3D point cloud, the 2D image, the pivot body 3D feature and the pivot edge 3D feature; obtaining a tip tangent plane corresponding to the tip edge 3D feature, and a pivot tangent plane corresponding to the pivot edge 3D feature, according to the length measuring vector, wherein the length measuring vector is a plane normal vector of the tip tangent plane and the pivot tangent plane; calculating the distance between the tip tangent plane and the pivot tangent plane, to obtain the assembling length of the clamping arm; and outputting a classifying signal according to the assembling length of the clamping arm. The system also includes at least one LED indicator, coupled to the computing device, which the at least one LED indicator receives the classifying signal to indicate a classification of the assembling length of the clamping arm.

### BRIEF DESCRIPTION OF THE DRAWINGS

FIG. 1 shows a diagram illustrating the clamping arms of the example hand tool, according to implementations of the disclosure.

FIG. 2A shows a block diagram illustrating the example system for classifying clamping arm of hand tool, l, according to implementations of the disclosure.

FIG. 2B shows a diagram illustrating the example system for classifying the clamping arms of hand tool, according to implementations of the disclosure.

FIG. 2C shows a diagram illustrating the jig tray holding the clamping arms, according to implementations of the disclosure.

FIG. 3A shows a diagram illustrating obtaining multiple edge point sets of the example clamping arm, according to implementations of the disclosure.

FIG. 3B shows a diagram illustrating obtaining multiple edge 3D features and respective length measuring vector by multiple edge point sets of the example clamping arm 100a of FIG. 3A.

FIG. 4A shows a diagram illustrating obtaining multiple edge point sets of another example clamping arm, according to implementations of the disclosure.

FIG. 4B shows a diagram illustrating obtaining multiple edge 3D features and respective length measuring vector 130b by multiple edge point sets of the example clamping arm 100b of FIG. 4A.

FIG. 5 shows a diagram illustrating obtaining tip tangent planes and pivot tangent planes of clamping arms by length measuring vectors of FIGS. 3B and 4B.

FIG. 6 shows a flowchart illustrating example procedure 600 for classifying the clamping arm of the hand tool, according to implementations of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

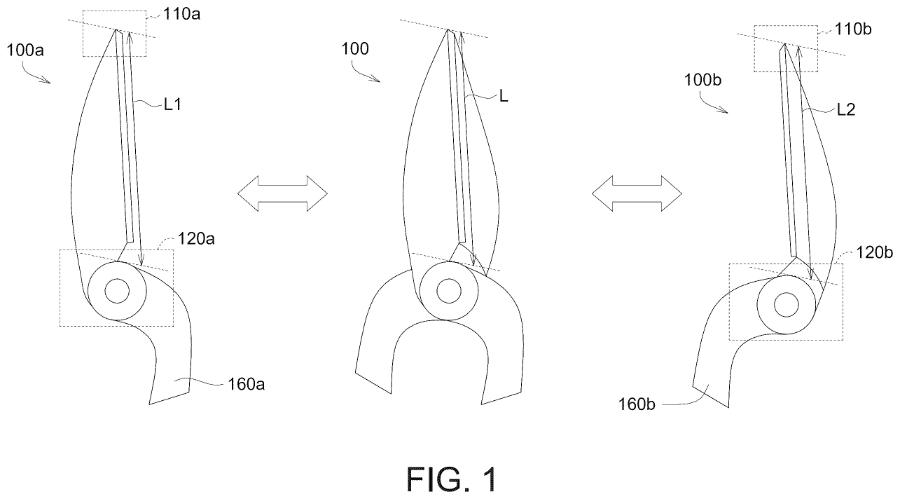

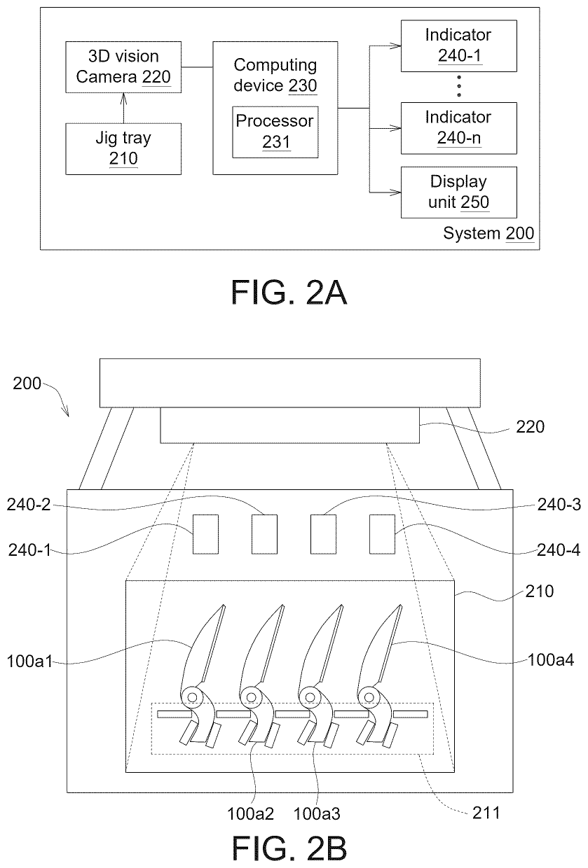

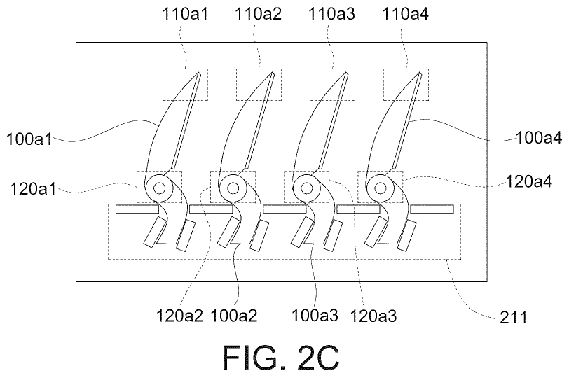

FIG. 1 shows a diagram illustrating the clamping arm 100a and the clamping arm 100b of the example hand tool 100, according to implementations of the disclosure. As shown by FIG. 1, the hand tool 100 can be pivotedly composed by the clamping arm 100a and the clamping arm 100b. Regarding the accuracy of the hand tool 100, the assembling length L1 of the clamping arm 100a and the assembling length L2 of the clamping arm 100b are required to be nearly equal, which must be as close as possible to the assembling matching length L of the hand tool 100 to increase the assembling accuracy of the hand tool 100. The clamping arm 100a comprises the tip portion 110a, the pivot portion 120a and the handheld portion 160a. The clamping arm 100b comprises the tip portion 110b, the pivot portion 120b and the handheld portion 160b. The tip portion 110a and the handheld portion 160a of the clamping arm 100a, and the tip portion 110b and the handheld portion 160b of the clamping arm 100b are respectively disposed on two sides of the pivot portion 120a of the clamping arm 100a, and two sides of the pivot portion 120b of the clamping arm 100b. The assembling length L1 and the assembling length L2 are respectively related to tip portion 110a and the pivot portion 120a of the clamping arm 100a, and related to the tip portion 110b and the pivot portion 120b of the clamping arm 100b. The hand tool measured by applying techniques provided by the disclosure can be pliers (or cutting nipper) with cutting edges at the tip, such as diagonal pliers or metal shears, or can be clamps with clamp portion at the tip, such as a vise or water pipe pliers. The hand tool 100 herein is a cutting nipper as an example, and the clamping arm 100a and the clamping arm 100b are respectively a left blade and a right blade of the cutting nipper as examples, but not a limited to. By applying the techniques provided by the disclosure, before assembling various types of hand tools, the size of assembling length of each clamping arm can be inspected, such as the distance between the pivot (in the pivot portion) and the tip (in the tip portion) of the clamping arm. As results, the measured size of the clamping arm can be classified and matched, to increase the assembling accuracy of the hand tool. The techniques provided by the disclosure will be detailed described referring to FIGS. 2A to 5 as follows.

FIG. 2A shows a block diagram illustrating the example system 200 for classifying clamping arm of hand tool, FIG. 2B shows a diagram illustrating the example system 200 for classifying the clamping arm 100a1 to the clamping arm 100a4 of hand tool, and FIG. 2C shows a diagram illustrating the jig tray 210 holding the clamping arm 100a1 to the clamping arm 100a4, according to implementations of the disclosure. Referring to FIGS. 2A to 2C, the example system 200 for classifying the clamping arm (such as the clamping arm 100a1 to the clamping arm 100a4 of FIGS. 2B and 2C, or the clamping arm 100a or the clamping arm 100b of FIG. 1) of the hand tool includes the jig tray 210 for holding the clamping arm. In some implementations, the jig tray 210 can be used for holding multiple clamping arms. In FIGS. 2B and 2C, the jig tray 210 holds four clamping arms, the clamping arm 100a1 to the clamping arm 100a4, as an example. The system 200 includes the 3D vision camera 220, for shooting the clamping arm on the jig tray 210, to scan the clamping arm and obtain the 3D point cloud and the 2D image of the clamping arm. In some implementations, the 3D vision camera scans multiple the clamping arm image to obtain 2D image, such as with a resolution of 3000×4000 pixels, and the 2D image can be in color or grayscale, which the 3D point cloud is corresponding to the resolution of the 2D image. In other words, each pixel corresponds to a set of definitions of actual spatial positions in X, Y and Z axis, which therefore, for example, the 3D point cloud includes multiple 3D points and may have floating point data of 3000×4000×3. The system 200 includes the computing device 230 coupled to the 3D vision camera 220. The computing device 230 can be configured to receive the 3D point cloud and the 2D image of the clamping arm captured by the 3D vision camera 220, and process the 3D point cloud of the clamping arm by the processor 231 of the computing device 230, to classify the assembling length of the clamping arm from the 3D point cloud of the clamping arm and output a classifying signal. The system 200 can include multiple LED indicators, the LED indicators 240-1 to the LED indicators 240-n, coupled to the computing device 230. The LED indicators 240-1 to the LED indicators 240-n can receive the classifying signal output by the computing device 230, to indicate the classification of the assembling length of the clamping arm by lights, such as indicating the size classification, large, middle or small, of the assembling length of the clamping arm by different colors of lights, which the number of the LED indicators can correspond to the number of the clamping arm on the jig tray 210. Thus, in the example of FIGS. 2B and 2C, the clamping arm held in the jig tray 210 are four (the clamping arm 100a1 to the clamping arm 100a4) with four corresponding LED indicators, the LED indicator 240-1 to the LED indicator LED 240-4, for respectively indicate the size classification of the assembling length of the clamping arm. In some implementations, the system 200 can include the display unit 250, which can be configured for display processes or results of the computing device 230 classifying the size the clamping arm in the 3D point cloud thereof, on the display unit 250.

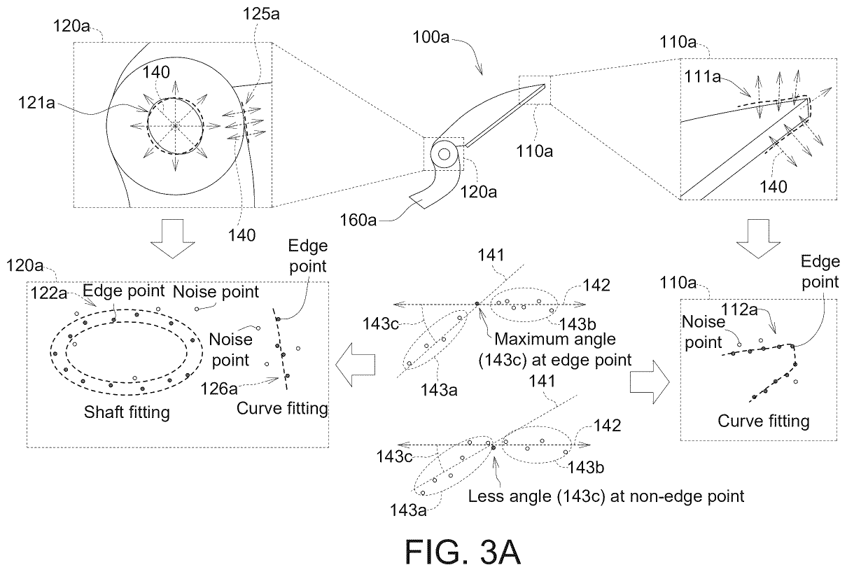

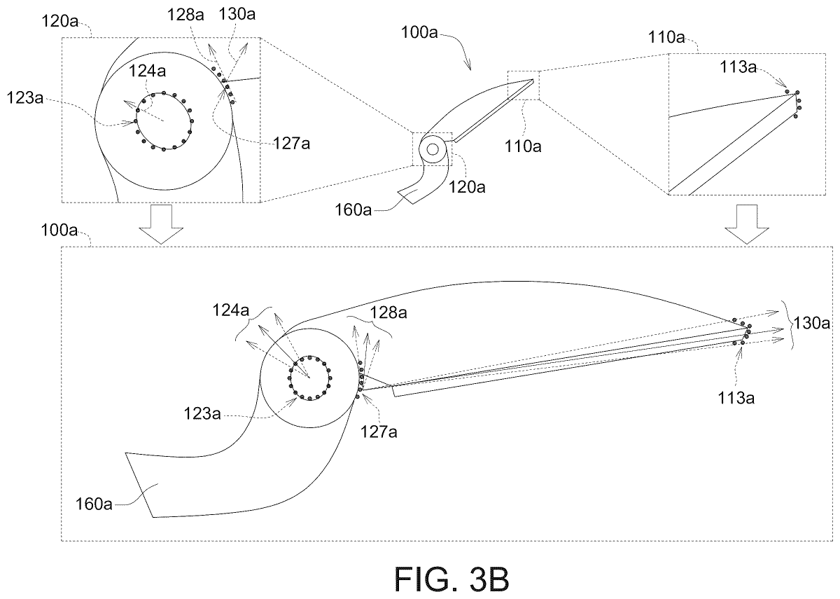

As shown by FIGS. 2B and 2C, the jig tray 210 can have holding portions 211 for holding the clamping arm 100a to the clamping arm 100a4 on the jig tray 210. In some implementations, according to multiple preset pivot portion locations (the pivot portion location 120a1 to the pivot portion location 120a4) and multiple preset tip portion locations (the tip portion location 110a1 to the tip portion location 110a4) in the jig tray 210 holding the clamping arm 100a1 to the clamping arm 100a4, the tip region of the tip portion and the pivot region of the pivot portion, of each clamping arm (each of the clamping arm 100a1 to the clamping arm 100a4) can be respectively determined in the 3D point cloud, to rapidly locate regions to be measured. In some implementations, through marking features images of tip portion locations (such as the tip portion location 110a1 to the tip portion location 110a4) corresponding to the tip region, in the 3D point cloud, of the tip portion of each clamping arm (each of the clamping arm 100a1 to the clamping arm 100a4), and features images of pivot portion locations (such as the pivot portion location 120a1 to the pivot portion location 120a4) corresponding to the pivot region, in the 3D point cloud, of the pivot portion of each clamping arm (each of the clamping arm 100a1 to the clamping arm 100a4), the AI model, such as deep learning model, can be trained to determine locations of the tip region, in the 3D point cloud, corresponding to tip portion, and locations of the pivot region, in the 3D point cloud, corresponding to the pivot portion, such as through the deep learning model. The deep learning model can be such as Convolutional Neural Network (CNN), Region CNN (R-CNN) or Fully Convolutional Network (RCN). The techniques of obtaining the assembling length of the clamping arm by the tip portion and the pivot portion of the clamping arm, provided by the disclosure, will be detailed described referring to FIGS. 3A to 5 as follows.

FIG. 3A shows a diagram illustrating obtaining multiple edge point sets (the tip edge point se t112a, the pivot body edge point set 122a, and the pivot edge point set 126a) of the example clamping arm 100a, according to implementations of the disclosure. After determining the tip portion 110a and the pivot portion 120a according to the tip region and the pivot region of the 3D point cloud, the tip edge 3D feature (such as the tip edge 3D feature 113a of FIG. 3B) of the tip portion 110a, and the pivot body 3D feature and the pivot edge 3D feature (such as the pivot body 3D feature 123a and the pivot edge 3D feature 127a of FIG. 3B) of the pivot portion 120a, will be than obtained according to the tip portion 110a and the pivot portion 120a of the clamping arm 100a.

As shown by upper part of the FIG. 3A, firstly, multiple 3D points, from the 3D point cloud, of the pivot region and the tip region, respectively corresponding to the pivot portion 120a and the tip portion 110a of the clamping arm 100a, are obtained, and the multiple 3D points form the 3D point cloud will be applied with 3D coordinate plane calibration. Then, the pivot body initial contour 121 and the pivot edge initial contour 125a of the pivot portion 120a, and the tip edge initial contour 111 of the tip portion 110a, are obtained according to the 2D image. In this case, the body, of the pivot portion 120a of the clamping arm 100a, is formed by a shaft with round hole as an example, but not limited to. For example, another body, of the pivot portion of the clamping arm, may be formed by a plane.

Next, multiple 3D sampling regions are built, through multiple indentation and expansion directions 140, at the pivot body initial contour 121, the pivot edge initial contour 125a and the tip edge initial contour 111, which are at location of the indentation and expansion directions 140 represented by multiple dashed arrows in FIG. 3A. The indentation and expansion directions 140 can be used as the start point and end point for searching the edge point in the point cloud. Then, as shown by lower middle part of FIG. 3A, at the location of foresaid multiple indentation and expansion directions 140 (the 3D sampling region), other body sampling 3D points, other edge sampling 3D points and other tip sampling 3D points, from the 3D point cloud, along each of indentation and expansion directions 140, on two sides of each of multiple body sampling 3D points, each of multiple edge sampling 3D points, and each of multiple tip sampling 3D points (as shown by solid black dots and hollow dots in lower part of FIG. 3A), form the 3D point cloud, on the multiple indentation and expansion directions 140 of the pivot body initial contour 121, the pivot edge initial contour 125a and the tip edge initial contour 111, are separated to the first 3D points cluster 143a and the second 3D points cluster 143b. The first 3D points cluster 143a and the second 3D points cluster 143b are fitting to form the first fitting line 141 and the second fitting line 142. Then, angle 143c between the first fitting line 141 and the second fitting line 142 is calculated, as shown by lower middle part of FIG. 3A.

The shaft with round hole, and the curve, of the pivot portion 120a are fitting to respectively obtain point clouds with the maximum angle corresponding to the angle 143c of the first fitting line 141 and the second fitting line 142, as edge points, from the multiple body sampling point clouds and the multiple edge sampling point clouds, on each of indentation and expansion directions 140 of the pivot body initial contour 121 and the pivot edge initial contour 125a, to form the pivot body edge point set 122a and the pivot edge point set 126a on each of the indentation and expansion directions 140, as shown by lower left part of FIG. 3A. Similarly, the curve of the tip portion 110a is fitting to obtain point clouds with the maximum angle corresponding to the angle 143c of the first fitting line 141 and the second fitting line 142, as edge points, from the multiple tip sampling point clouds on each of indentation and expansion directions 140 of the tip edge initial contour 111 to form the tip edge point set 112a on each of the indentation and expansion directions 140, as shown by lower right part of FIG. 3A.

Next, referring to FIG. 3B, which shows a diagram illustrating obtaining multiple edge 3D features (the tip edge 3D feature 113a, the pivot body 3D feature 123a, and the pivot edge 3D feature 127a) and respective length measuring vector 130a by multiple edge point sets (the tip edge point set 112a, the pivot body edge point set 122a and the pivot edge point set 126a) of the example clamping arm 100a of FIG. 3A. Firstly, an optimization convergence function can be used on the tip edge point set 112a, the pivot body edge point set 122a and the pivot edge point set 126a to respectively form the tip edge 3D feature 113a, the pivot body 3D feature 123a, the and pivot edge 3D feature 127a, and to remove noise points (such as hollow dots of FIG. 3A) in multiple tip sampling 3D points, multiple body sampling 3D points and multiple edge sampling 3D points, from the 3D point cloud, as shown by upper right part and upper left part of FIG. 3B. The optimization convergence function includes various 3D feature optimizing fitting depending the pivot portion/the tip portion formed by curve or round hole. Then, the length measuring vector 130a of the pivot portion 120a is calculated according to the pivot body edge point set 122a and the pivot edge point set 126a. In some implementations, to calculate the length measuring vector 130a, multiple projecting 3D points can be obtain by projecting the pivot body 3D feature 123a to a pivot edge of the pivot portion (such as the location of the pivot edge initial contour 125a). The 3D straight line fitting of the multiple projecting 3D points and the pivot edge 3D feature 127a can be performed to form the pivot edge vector 128a, and cross product of the pivot body normal vector 124a, of the pivot body 3D feature 123a, and the pivot edge vector 128a can be perform to obtain the length measuring vector 130a, as shown by upper left part of FIG. 3B. It should be noticed that, since the clamping arm 100a is not completely flat, which its surface may have curvature or unevenness, each feature point in the tip edge 3D feature 113a, the pivot body 3D feature 123a and the pivot edge 3D feature 127a may not be located at the same plane. Therefore, the pivot edge vector 128a formed by 3D straight line fitting of the pivot edge 3D feature 127a and the multiple projecting 3D points obtained, by projecting the pivot body 3D feature 123a to the pivot edge of the pivot portion, may be multiple, and performing cross product of multiple pivot edge vectors 128a and multiple pivot body normal vectors 124a also obtains multiple length measuring vectors 130a, as shown by lower part of FIG. 3B.

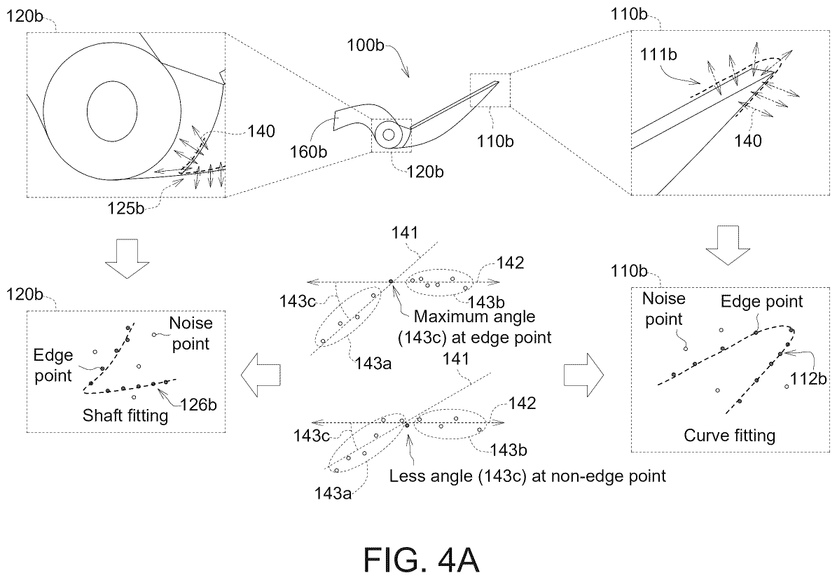

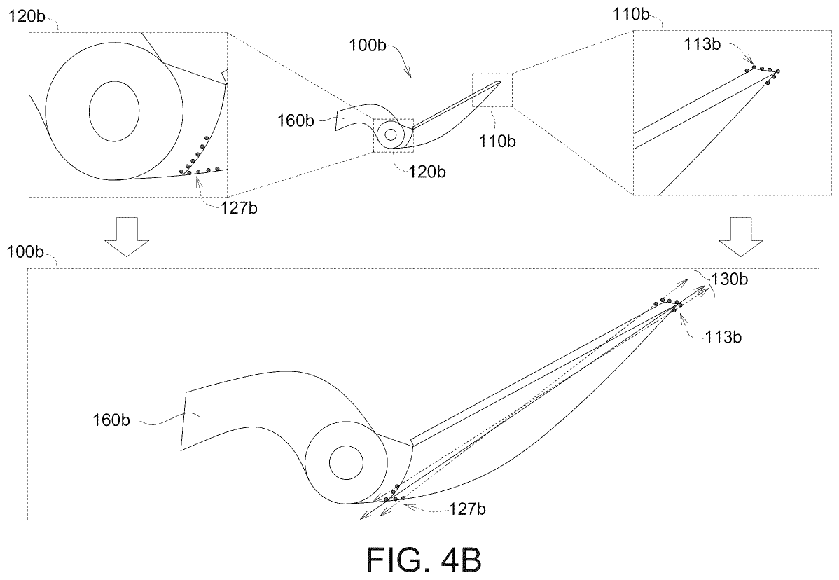

FIG. 4A shows a diagram illustrating obtaining multiple edge point sets (the tip edge point set 112b, and the pivot edge point set 126b) of another example clamping arm 100b, according to implementations of the disclosure. Similarly with the description referring to FIG. 3A, after determining the tip portion 110b and the pivot portion 120b of the clamping arm 100b according to the tip region and the pivot region of the 3D point cloud, the tip edge 3D feature (such as the tip edge 3D feature 113b of FIG. 4B) of the tip portion 110b, and the pivot edge 3D feature (such as the pivot edge 3D feature 127b of FIG. 4B) of the pivot portion 120b, will be than obtained according to the tip portion 110b and the pivot portion 120b of the clamping arm 100b.

As shown by upper part of the FIG. 4A, firstly, multiple point clouds, in the 3D point cloud, of the pivot region and the tip region, respectively corresponding to the pivot portion 120b and the tip portion 110b of the clamping arm 100b, are obtained, and the multiple point clouds will be applied with 3D coordinate plane calibration. Then, the pivot edge initial contour 125b of the pivot portion 120b, and the tip edge initial contour 111b of the tip portion 110b, are obtained according to the 2D image.

Next, multiple 3D sampling regions are built, through multiple indentation and expansion directions 140, at the pivot edge initial contour 125b and the tip edge initial contour 111b, which are at location of the indentation and expansion directions 140 represented by multiple dashed arrows in FIG. 4A. The indentation and expansion directions 140 can be used as the start point and end point for searching the edge point in the point cloud. Then, as shown by lower middle part of FIG. 4A, at the location of foresaid multiple indentation and expansion directions 140 (the 3D sampling region), other edge sampling point clouds and other tip sampling point clouds, along each of indentation and expansion directions 140, on two sides of each of multiple edge sampling point clouds and each of multiple tip sampling point clouds (as shown by solid black dots and hollow dots in lower part of FIG. 4A), on the multiple indentation and expansion directions 140 of the pivot edge initial contour 125b and the tip edge initial contour 111a, are separated to the first 3D points cluster 143a and the second 3D points cluster 143b. The first 3D points clustered point cloud 143a and the second 3D points cluster 143b are fitting to form the first fitting line 141 and the second fitting line 142. Then, angle 143c between the first fitting line 141 and the second fitting line 142 is calculated, as shown by lower middle part of FIG. 4A.

The shaft with round hole the pivot portion 120b, and the curve of the pivot portion 120a are respectively fitting to obtain point clouds with the maximum angle corresponding to the angle 143c of the first fitting line 141 and the second fitting line 142, as edge points, from the multiple edge sampling point clouds and the multiple tip sampling point clouds, on each of indentation and expansion directions 140 of the pivot edge initial contour 125b and the tip edge initial contour 111b, to form the pivot edge point set 126b and the tip edge point set 112b on each of the indentation and expansion directions 140, as shown by lower left part and lower right part of FIG. 4A.

Next, referring to FIG. 4B, which shows a diagram illustrating obtaining multiple edge 3D features (the tip edge 3D feature 113b and the pivot edge 3D feature 127b) and respective length measuring vector 130b by multiple edge point sets (the tip edge point set 112b and the pivot edge point set 126b) of the example clamping arm 100b of FIG. 4A. Firstly, an optimization convergence function can be used on the tip edge point set 112b and the pivot edge point set 126b to respectively form the tip edge 3D feature 113b and pivot edge 3D feature 127b, and to remove noise points (such as hollow dots of FIG. 3A) in multiple tip sampling 3D points and multiple edge sampling 3D points, from the 3D point cloud, as shown by upper right part and upper left part of FIG. 4B. The optimization convergence function includes various 3D feature optimizing fitting depending the pivot portion/the tip portion formed by curve or round hole. Then, the length measuring vector 130b is obtained according to the line between the tip edge 3D feature 113b and the pivot edge 3D feature 127b. It should be noticed that, since the clamping arm 100b is not completely flat, which its surface may have curvature or unevenness, each feature point in the tip edge 3D feature 113b and the pivot edge 3D feature 127b may not be located at the same plane. Therefore, the pivot edge vector 128b obtained by lines between the tip edge 3D feature 113b and the pivot edge 3D feature 127b, may be multiple, as shown by lower part of FIG. 4B.

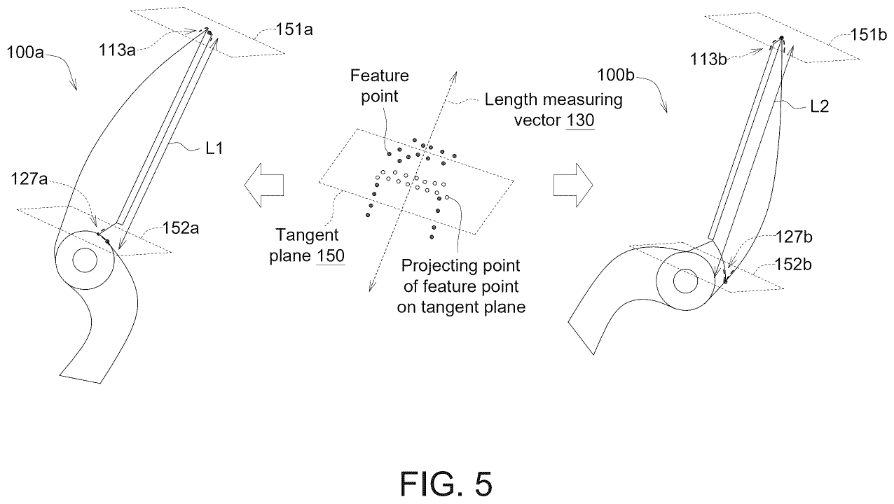

FIG. 5 shows a diagram illustrating obtaining tip tangent planes (the tip tangent plane 151a and the tip tangent plane 151b) and pivot tangent planes (the pivot tangent plane 152a and the pivot tangent plane 152b) of clamping arms (the clamping arm 100a and the clamping arm 100b) by length measuring vectors (the length measuring vector 130a and the length measuring vector 130b) of FIGS. 3B and 4B. As shown by middle part of FIG. 5, the tangent plane 150 can be define in the direction along the length measuring vector 130 (can be multiple foresaid length measuring vectors 130a or multiple foresaid length measuring vectors 130b), and multiple feature points (such as multiple solid points in FIG. 5) of 3D features (such as foresaid pivot edge 3D feature or foresaid tip edge 3D feature) have multiple projecting 3D points on the tangent plane 150 (such as multiple hollow points in FIG. 5). Thus, when the tangent plane 150 moves along the length measuring vector 130, according to the distance between the projecting 3D points and the accrual feature points, the tangent plane with the minimum distance therebetween can be used as the optimized tangent plane (by minimize recursion analysis), while the optimized tangent plane partially aligned (or partially overlapped) with the 3D feature (such as foresaid pivot edge 3D feature or foresaid tip edge 3D feature). Accordingly, for the clamping arm 100a, along the length measuring vector 130a, the tangent plane, having minimum distance to the tip edge 3D feature 113a, can be used as the tip tangent plane 151a (by minimize recursion analysis), and the tangent plane, having minimum distance between the tip edge 3D feature 113a and projecting 3D points projected by the tip edge 3D feature 113a on the tangent plane, can be used as the pivot tangent plane 152a (by minimize recursion analysis), while the tip tangent plane 151a and the pivot tangent plane 152a being respectively, partially, aligned (or partially overlapped) with the tip edge 3D feature 113a and the pivot edge 3D feature 127a. Similarly, for the clamping arm 100b, the tangent plane, having minimum distance to the tip edge 3D feature 113b along the length measuring vector 130b, can be used as the tip tangent plane 151b (by minimize recursion analysis), and the tangent plane, having minimum distance between the tip edge 3D feature 113b and projecting 3D points projected by the tip edge 3D feature 113b on the tangent plane, can be used as the pivot tangent plane 152b (by minimize recursion analysis), while the tip tangent plane 151b and the pivot tangent plane 152b being respectively, partially, aligned (or partially overlapped) with the tip edge 3D feature 113b and the pivot edge 3D feature 127b.

As discussed above, since the clamping arm 100a or the clamping arm 100b is not completely flat, which its surface may have curvature or unevenness, the obtained measuring vector 130a or the length measuring vector 130b may be multiple. Thus, regrading different length measuring vectors 130a or different length measuring vectors 130b, multiple tangent plane sets (including the tip tangent plane and the pivot tangent plane) respectively corresponding to the tip edge 3D feature 113a and the pivot edge 3D feature 127a of the clamping arm 100a, can be obtained, or multiple tangent plane sets (including the tip tangent plane and the pivot tangent plane) respectively corresponding to the tip edge 3D feature 113b and the pivot edge 3D feature 127b of the clamping arm 100b, can be obtained. Among those tangent plane sets, the tangent plane set, having the maximum distance between the pivot tangent plane and the tip tangent plane, can be obtained, and the assembling length of the clamping arm can be classified according to the maximum distance. For example, as shown by left part and right part of FIG. 5, for the clamping arm 100a, the assembling length L1 with the maximum distance between the tip tangent plane 151a and the pivot tangent plane 152a can be used for classification, and, for the clamping arm 100b, the assembling length L2 with the maximum distance between the tangent plane 151b and the pivot tangent plane 152b can be used for classification. Also, the assembling length L1 and the assembling length L2, respectively, are plane normal vectors between the tip tangent plane 151a and the pivot tangent plane 152a, and between the tip tangent plane 151b and the pivot tangent plane 152b.

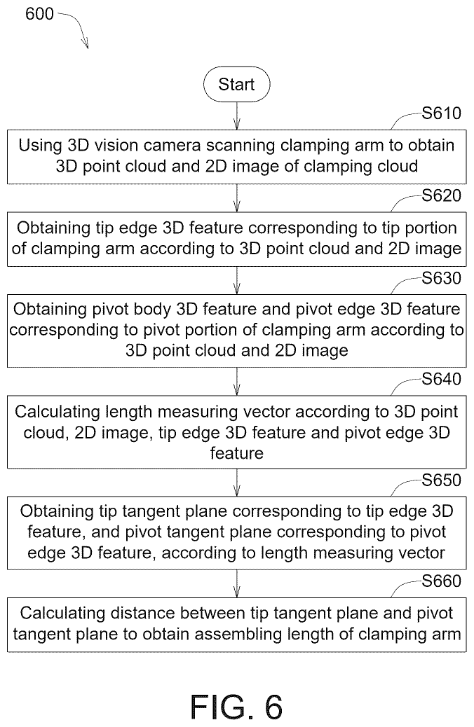

FIG. 6 shows a flowchart illustrating example procedure 600 for classifying the clamping arm of the hand tool, according to implementations of the disclosure. In step S610, the 3D vision camera is used for scanning the clamping arm, to obtain the 3D point cloud and the 2D image of the clamping arm. In step S620, obtains the tip edge 3D feature corresponding to the tip portion of the clamping arm according to the 3D point cloud and the 2D image. In step S630, obtains the pivot body 3D feature and the pivot edge 3D feature corresponding to the pivot portion of the clamping arm according to the 3D point cloud and the 2D image. In step S640, calculates the length measuring vector according to the 3D point cloud, the 2D image, the tip edge 3D feature and the pivot edge 3D feature. In step S650, obtains the tip tangent plane corresponding to the tip edge 3D feature, and the pivot tangent plane corresponding to the pivot edge 3D feature, according to the length measuring vector. In step S660, calculates the distance between the tip tangent plane and the pivot tangent plane, to obtain the assembling length of the clamping arm.

In certain configurations, the computing device obtains the tip edge 3D feature according to a tip region, corresponding to the tip portion, in the 3D point cloud and the 2D image, and obtains the pivot body 3D feature and the pivot edge 3D feature according to a pivot region, corresponding to the pivot portion, in the 3D point cloud and the 2D image.

In certain configurations, the tip region, corresponding to the tip portion, in the 3D point cloud, and the pivot region, corresponding to the pivot portion, in the 3D point cloud, are respectively obtained according to multiple preset tip portion locations and multiple preset pivot portion locations on a jig tray holding the clamping arm.

In certain configurations, the tip region, corresponding to the tip portion, in the 3D point cloud, and the pivot region, corresponding to the pivot portion, in the 3D point cloud, are determined by a deep learning model.

In certain configurations, obtaining the tip 3D edge feature at the tip portion comprises: obtaining multiple 3D points corresponding to the tip portion from the 3D point cloud, according to the tip region; obtaining an initial contour of the tip portion of the clamping arm in the 2D image; defining a 3D sampling region by indentation and expansion from the initial contour of the 2D image; obtaining multiple of tip sampling 3D points from the 3D point cloud, according to the 3D sampling region; separating the tip sampling 3D points by the initial contour to a first 3D points cluster and a second 3D points cluster; fitting, respectively, the first 3D points cluster and the second 3D points cluster into a first fitting line and a second fitting line, and calculating an angle between the first fitting line and the second fitting line; obtaining an edge point, with the maximum angle between the first fitting line and the second fitting line, from the multiple tip sampling 3D points on each of multiple indentation and expansion directions of the initial contour, to form a tip edge point set, of the tip portion, on the multiple indentation and expansion directions; and using an optimization convergence function on the tip edge point set to form the tip edge 3D feature and remove noise points in the multiple tip sampling 3D point.

In certain configurations, obtaining the pivot body 3D feature and the pivot edge 3D feature at the pivot portion comprises: obtaining multiple 3D points corresponding to a pivot body and a pivot edge of the pivot portion from the 3D point cloud, according to the 3D sampling region; obtaining an initial contour of the pivot body and the pivot edge of the pivot portion of the clamping arm in the 2D image; defining a 3D sampling region by indentation and expansion from the initial contour of the 2D image; obtaining multiple body sampling 3D points and multiple edge sampling 3D points, according to the 3D sampling region; separating the multiple body sampling 3D points and the multiple edge sampling 3D points to a first 3D points cluster and a second 3D points cluster; fitting, respectively, the first 3D points cluster and the second 3D points cluster into a first fitting line and a second fitting line, and calculating an angle between the first fitting line and the second fitting line; obtaining an edge point, with the maximum angle between the first fitting line and the second fitting line, from the multiple body sampling point clouds and the multiple edge sampling point clouds, on each of multiple indentation and expansion directions of the initial contour, to form a pivot body edge point set of the pivot body, on the multiple indentation and expansion directions, and to form a pivot edge point set of the pivot edge, on the multiple indentation and expansion directions; and using an optimization convergence function on the pivot body edge point set and the pivot edge point set, respectively, to form the pivot body 3D feature and the pivot edge 3D feature, and to remove noise points in the multiple body sampling 3D points and the multiple edge sampling 3D points.

In certain configurations, calculating the length measuring vector comprises: obtaining multiple projecting 3D points by projecting the pivot body 3D feature to a pivot edge of the pivot portion, and performing 3D straight line fitting of the multiple projecting 3D points and the pivot edge 3D feature to form a pivot edge vector; and performing cross product of a pivot body normal vector, of the pivot body 3D feature, and the pivot edge vector to obtain the length measuring vector.

In certain configurations, obtaining the tip tangent plane corresponding to the tip edge 3D feature, and the pivot tangent plane corresponding to the pivot edge 3D feature, comprises: using a tangent plane, having the shortest distance to the tip edge 3D feature along a direction of the length measuring vector, as the tip tangent plane, and using a tangent plane, having the shortest distance to the pivot edge 3D feature along a direction of the length measuring vector, as the pivot tangent plane. Locations of the tip tangent plane and the pivot tangent plane are obtained according to a minimize recursion analysis. The tip tangent plane is partially aligned with the tip edge 3D feature, and the pivot tangent plane is partially aligned with the pivot edge 3D feature.

In certain configurations, calculating the distance between the tip tangent plane and the pivot tangent plane comprises: calculating multiple length measuring vector matching the pivot edge 3D feature and the tip edge 3D feature; obtaining multiple tangent plane sets corresponding to each of the multiple length measuring vector; obtaining a tangent plane set, having a longest length of the plane normal vector between the tip tangent plane and the pivot tangent plane, from the multiple tangent plane sets; and using the plane normal vector of the tangent plane set as the assembling length of the clamping arm.

The techniques of the implementations above provided by the disclosure, by the 3D vision camera, obtain edge 3D features and tangent plane sets of each clamping arm of the hand tool, to measure the size of the assembling length, which can measure multiple clamping arms in a wide range at the same time and classify their assembling lengths. Since the tangent plane in 3D space has six degrees of freedom, the techniques provided by the disclosure achieves the effect of stably measuring dimensions, by obtaining the length measuring vector of 3D feature sets of the hand tool.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A method for measuring assembling length of clamping arm of hand tool, the method comprising:
obtaining, by using a 3D vision camera scanning the clamping arm, a 3D point cloud and a 2D image of the clamping arm;
obtaining, by a computing device, a tip edge 3D feature corresponding to a tip portion of the clamping arm, according to the 3D point cloud and the 2D image;
obtaining, by the computing device, a pivot body 3D feature and a pivot edge 3D feature corresponding to a pivot portion of the clamping arm, according to the 3D point cloud and the 2D image;
calculating, by the computing device, a length measuring vector, according to the 3D point cloud, the 2D image, the pivot body 3D feature and the pivot edge 3D feature;
obtaining, by the computing device, a tip tangent plane corresponding to the tip edge 3D feature, and a pivot tangent plane corresponding to the pivot edge 3D feature, according to the length measuring vector; and
calculating, by the computing device, a distance between the tip tangent plane and the pivot tangent plane, to obtain the assembling length of the clamping arm,
wherein the length measuring vector is a plane normal vector of the tip tangent plane and the pivot tangent plane.

2. The method of claim 1, wherein the computing device obtains the tip edge 3D feature according to a tip region, corresponding to the tip portion, in the 3D point cloud and the 2D image, and obtains the pivot body 3D feature and the pivot edge 3D feature according to a pivot region, corresponding to the pivot portion, in the 3D point cloud and the 2D image.

3. The method of claim 2, wherein the tip region, corresponding to the tip portion, in the 3D point cloud, and the pivot region, corresponding to the pivot portion, in the 3D point cloud, are respectively obtained according to a plurality of preset tip portion locations and a plurality of preset pivot portion locations on a jig tray holding the clamping arms.

4. The method of claim 2, wherein the tip region, corresponding to the tip portion, in the 3D point cloud, and the pivot region, corresponding to the pivot portion, in the 3D point cloud, are determined by a deep learning model.

5. The method of claim 2, wherein obtaining the tip edge 3D feature at the tip portion comprises:
obtaining a plurality of 3D points corresponding to the tip portion from the 3D point cloud, according to the tip region;
obtaining an initial contour of the tip portion of the clamping arm in the 2D image;
defining a 3D sampling region by indentation and expansion from the initial contour of the 2D image;
obtaining a plurality of tip sampling 3D points from the 3D point cloud, according to the 3D sampling region;
separating the tip sampling 3D points by the initial contour to a first 3D point cluster and a second 3D point cluster;
fitting, respectively, the first 3D points cluster and the second 3D points cluster into a first fitting line and a second fitting line, and calculating an angle between the first fitting line and the second fitting line;
obtaining an edge point, with the maximum angle between the first fitting line and the second fitting line, from the plurality of tip sampling 3D points on each of a plurality of indentation and expansion directions of the initial contour, to form a tip edge point set, of the tip portion, on the plurality of indentation and expansion directions; and
using an optimization convergence function on the tip edge point set to form the tip edge 3D feature and remove noise points in the plurality of tip sampling 3D points.

6. The method of claim 2, wherein obtaining the pivot body 3D feature and the pivot edge 3D feature at the pivot portion comprises:
obtaining a plurality of 3D points corresponding to a pivot body and a pivot edge of the pivot portion from the 3D point cloud, according to the pivot region;
obtaining an initial contour of the pivot body and the pivot edge of the pivot portion of the clamping arm in the 2D image;
defining a 3D sampling region by indentation and expansion from the initial contour of the 2D image;
obtaining a plurality of body sampling 3D points and a plurality of edge sampling 3D points, from the 3D point cloud, according to the 3D sampling region;
separating the plurality of body sampling 3D points and the plurality of edge sampling 3D points by the initial contour to a first 3D point cluster and a second 3D point cluster;
fitting, respectively, the first 3D point cluster and the second 3D point cluster into a first fitting line and a second fitting line, and calculating an angle between the first fitting line and the second fitting line;
obtaining an edge point, with the maximum angle between the first fitting line and the second fitting line, from the plurality of body sampling 3D points and the plurality of edge sampling 3D points, on each of a plurality of indentation and expansion directions of the initial contour, to form a pivot body edge point set of the pivot body, on the plurality of indentation and expansion directions, and to form a pivot edge point set of the pivot edge, on the plurality of indentation and expansion directions; and
using an optimization convergence function on the pivot body edge point set and the pivot edge point set, respectively, to form the pivot body 3D feature and the pivot edge 3D feature, and to remove noise points in the plurality of body sampling 3D points and the plurality of edge sampling 3D points.

7. The method of claim 2, wherein calculating the length measuring vector comprises:
obtaining a plurality of projecting 3D points by projecting the pivot body 3D feature to a pivot edge of the pivot portion, and performing 3D straight line fitting of the plurality of projecting 3D points and the pivot edge 3D feature to form a pivot edge vector; and
performing cross product of a pivot body normal vector, of the pivot body 3D feature, and the pivot edge vector to obtain the length measuring vector.

8. The method of claim 7, wherein obtaining the tip tangent plane corresponding to the tip edge 3D feature, and the pivot tangent plane corresponding to the pivot edge 3D feature, comprises:
using a tangent plane, having the shortest distance to the tip edge 3D feature along a direction of the length measuring vector, as the tip tangent plane, and using a tangent plane, having the shortest distance to the pivot edge 3D feature along the direction of the length measuring vector, as the pivot tangent plane,
wherein locations of the tip tangent plane and the pivot tangent plane are obtained according to a minimize recursion analysis,
wherein the tip tangent plane is partially aligned with the tip edge 3D feature, and the pivot tangent plane is partially aligned with the pivot edge 3D feature.

9. The method of claim 8, wherein calculating the distance between the tip tangent plane and the pivot tangent plane comprises:
calculating a plurality of length measuring vector matching the pivot edge 3D feature and the tip edge 3D feature;
obtaining a plurality of tangent plane sets corresponding to each of the plurality of length measuring vector;
obtaining a tangent plane set, having a longest length of the plane normal vector between the tip tangent plane and the pivot tangent plane, from the plurality of tangent plane sets; and
using the plane normal vector of the tangent plane set as the assembling length of the clamping arm.

10. A system for measuring assembling length of clamping arm of hand tool, comprising:
a jig tray, configured for holding the clamping arm;
a 3D vision camera, configured to scan the clamping arm in the jig tray, to obtain a 3D point cloud and a 2D image of the clamping arm;
a computing device, coupled to the 3D vision camera and comprising a processor configured to perform following operations:
obtaining a tip edge 3D feature corresponding to a tip portion of the clamping arm, according to the 3D point cloud and the 2D image;
obtaining, by determining a pivot portion of the clamping arm, a pivot body 3D feature and a pivot edge 3D feature in the pivot portion, according to the 3D point cloud and the 2D image;
calculating a length measuring vector, according to the 3D point cloud, the 2D image, the pivot body 3D feature and the pivot edge 3D feature;
obtaining a tip tangent plane corresponding to the tip edge 3D feature, and a pivot tangent plane corresponding to the pivot edge 3D feature, according to the length measuring vector, wherein the length measuring vector is a plane normal vector of the tip tangent plane and the pivot tangent plane;
calculating a distance between the tip tangent plane and the pivot tangent plane, to obtain the assembling length of the clamping arm; and
outputting a classifying signal according to the assembling length of the clamping arm; and
at least one LED indicator, coupled to the computing device, which the at least one LED indicator receives the classifying signal to indicate a classification of the assembling length of the clamping arm.

11. The system of claim 10, wherein the computing device obtains the tip edge 3D feature according to a tip region, corresponding to the tip portion, in the 3D point cloud and the 2D image, and obtains the pivot body 3D feature and the pivot edge 3D feature according to a pivot region, corresponding to the pivot portion, in the 3D point cloud and the 2D image.

12. The system of claim 11, wherein the tip region, corresponding to the tip portion, in the 3D point cloud, and the pivot region, corresponding to the pivot portion, in the 3D point cloud, are respectively obtained according to a plurality of preset tip portion locations and a plurality of preset pivot portion locations on the jig tray holding the clamping arm.

13. The system of claim 11, wherein the tip region, corresponding to the tip portion, from the 3D point cloud, and the pivot region, corresponding to the pivot portion, from the 3D point cloud, are determined by a deep learning model.

14. The system of claim 11, wherein obtaining the tip edge 3D feature at the tip portion comprises:
obtaining a plurality of 3D points corresponding to the tip portion from the 3D point cloud, according to the tip region;
obtaining an initial contour of the tip portion of the clamping arm in the 2D image;
defining a 3D sampling region by indentation and expansion from the initial contour of the 2D image;
obtaining a plurality of tip sampling 3D points, from the 3D point cloud, according to the 3D sampling region;
separating the plurality of tip sampling 3D points by the initial contour, to a first 3D point cluster and a second 3D point cluster;
fitting, respectively, the first 3D point cluster and the second 3D point cluster into a first fitting line and a second fitting line, and calculating an angle between the first fitting line and the second fitting line;
obtaining an edge point, with the maximum angle between the first fitting line and the second fitting line, from the plurality of tip sampling 3D points on each of a plurality of indentation and expansion directions of the initial contour, to form a tip edge point set, of the tip portion, on the plurality of indentation and expansion directions; and
using an optimization convergence function on the tip edge point set to form the tip edge 3D feature and remove noise points in the plurality of tip sampling 3D points.

15. The system of claim 11, wherein obtaining the pivot body 3D feature and the pivot edge 3D feature at the pivot portion comprises:
obtaining a plurality of 3D points corresponding to a pivot body and a pivot edge of the pivot portion from the 3D point cloud, according to the pivot region;
obtaining an initial contour of the pivot body and the pivot edge of the pivot portion of the clamping arm in the 2D image;
defining a 3D sampling region by indentation and expansion from the initial contour of the 2D image;
obtaining a plurality of body sampling 3D points and a plurality of edge sampling 3D points from the 3D point cloud, according to the 3D sampling region;
separating the plurality of body sampling 3D points and the plurality of edge sampling 3D points based on the initial contour to a first 3D points cluster and a second 3D point cluster;
fitting, respectively, the first 3D points cluster and the second 3D point cluster into a first fitting line and a second fitting line, and calculating an angle between the first fitting line and the second fitting line;
obtaining an edge point, with the maximum angle between the first fitting line and the second fitting line, from the plurality of body sampling 3D points and the plurality of edge sampling 3D points, on each of a plurality of indentation and expansion directions of the initial contour, to form a pivot body edge point set of the pivot body, on the plurality of indentation and expansion directions, and to form a pivot edge point set of the pivot edge, on the plurality of indentation and expansion directions; and
using an optimization convergence function on the pivot body edge point set and the pivot edge point set, respectively, to form the pivot body 3D feature and the pivot edge 3D feature, and to remove noise points in the plurality of body sampling 3D points and the plurality of edge sampling 3D points.

16. The system of claim 11, wherein calculating the length measuring vector comprises:
obtaining a plurality of projecting 3D points by projecting the pivot body 3D feature to a pivot edge of the pivot portion, and performing 3D straight line fitting of the plurality of projecting 3D points and the pivot edge 3D feature to form a pivot edge vector; and
performing cross product of a pivot body normal vector, of the pivot body 3D feature, and the pivot edge vector to obtain the length measuring vector.

17. The system of claim 16, wherein obtaining the tip tangent plane corresponding to the tip edge 3D feature, and the pivot tangent plane corresponding to the pivot edge 3D feature, comprises:
using a tangent plane, having the shortest distance to the tip edge 3D feature along a direction of the length measuring vector, as the tip tangent plane, and using a tangent plane, having the shortest distance to the pivot edge 3D feature along the direction of the length measuring vector, as the pivot tangent plane,
wherein locations of the tip tangent plane and the pivot tangent plane are obtained according to a minimize recursion analysis,
wherein the tip tangent plane is partially aligned with the tip edge 3D feature, and the pivot tangent plane is partially aligned with the pivot edge 3D feature.

18. The system of claim 17, wherein calculating the distance between the tip tangent plane and the pivot tangent plane comprises:
calculating a plurality of length measuring vectors matching the pivot edge 3D feature and the tip edge 3D feature;
obtaining a plurality of tangent plane sets corresponding to each of the plurality of length measuring vectors;
obtaining a tangent plane set, having a longest length of the plane normal vector between the tip tangent plane and the pivot tangent plane, from the plurality of tangent plane sets; and
using the plane normal vector of the tangent plane set as the assembling length of the clamping arm.
